(19) United States
(12) Patent Application Publication
(10) Pub. No.: US 2015/0081663 A1
(43) Pub. Date: Mar. 19, 2015

(54) SYSTEM AND METHOD FOR ACTIVE SEARCH ENVIRONMENT

(71) Applicant: First Principles, Inc., Albany, NY (US)

(72) Inventor: Keith A. Raniere, Clifton Park, NY (US)

(73) Assignee: First Principles, Inc., Albany, NY (US)

(21) Appl. No.: 14/030,595

(22) Filed: Sep. 18, 2013

(51) Int. Cl. G06F 17/30

(52) U.S. Cl. CPC G06F 17/30867
USPC 707/708

(57) ABSTRACT

A method and system for generating customized user content, wherein user content is a product of an active search environment. Under the active search environment, a computing device may log, record and store all information on the computing device's interactions with the user. The computing device may utilize the stored information to actively search and present additional content to the user that the user may enjoy. The computing device may further predict content that may appeal to the user or retrieve additional or related content the user might have searched for in the future, streamlining the user's interaction.

### FIELD OF TECHNOLOGY

The following relates to a system and method for increasing the productivity of a computing device, and more specifically to embodiments of a computing device that saves and analyzes a user's actions to provide to the user with customized content based on the computing device's analysis.

### BACKGROUND

Modern day computing devices are rigidly programmed instruments. Computing devices do not respond, adapt or retrieve information for their user, unless the user requests the information directly. Many computing devices sit idle or enter a state of decreased functionality when they are not specifically being requested to perform a function. The time a computing device spends sitting idle is a waste of computing resources. Furthermore, current computing devices are not proficient in predicting user habits and content best suited to their user's needs. Computing devices typically do not have access to a large enough supply of user data to accurately predict user behavior or tailor content specifically to the user. Current systems for predicting user habits draw from too narrow of a data pool, such as a series of search engine queries made to a specific search engine, or browsing habits that are compartmentalized by a website. Current computing devices do not aggregate every interaction experienced by the computing device into a user profile or keep track of everything the user experiences.

Therefore, because computing devices are unnecessarily inactive and because computing devices are unable to accurately predict or suggest user content, a need exists for a method and system for tracking, analyzing and researching user activity in order to present and provide useful, customized user content.

### SUMMARY

A first aspect of this disclosure relates generally to a method comprising the steps of collecting, by a processor of a computing system, information of a user, analyzing, by the processor of the computing system, the information of the user to generate content based on the collected information of the user and presenting, by the processor of the computer system, the content when the computing system is not idle.

A second aspect of this disclosure relates generally to a computer system for actively searching and improving information available to a user comprising a processor, a computer-readable memory, a computer-readable storage device, first program instructions for storing user input, second program instruction for parsing user input into at least one keyword, third program instructions for generating a database including the at least one keyword, fourth program instructions for selecting a database entry from the database, fifth program instructions for searching an information repository for information related to the data entry from the database and sixth program instructions for displaying information retrieved relating to the search of the information repository, wherein the first program instructions, the second program instructions, the third program instructions, the fourth program instructions, the fifth program instructions and the sixth program instructions are stored on the computer-readable storage device for execution by the processor via the computer-readable memory.

A third aspect of this disclosure relates generally to a method for actively searching comprising the steps of receiving, by a processor, input from a user, parsing, by the processor, the input into at least one keyword, generating, by the processor, a database entry including the at least one keyword, selecting, by the processor, at least one database entry, searching, by the processor, a information repository for information relating to the at least one database entry, compiling, by the processor, the information relating to the at least one database entry and presenting, by the processor, the information to at least one user.

A forth aspect of this disclosure relates generally to a computer program product for actively searching and improving information available to a user comprising a computer-readable storage device, first program instructions for generating a database of user input, second program instructions for converting the user input into a database entry of at least one keyword, third program instructions for selecting at least one database entry for further analysis, fourth program instructions for searching an information repository for information relating to the at least one database entry, fifth program instructions for compiling information related to the at least one database entry and sixth program instructions for presenting the compiled information to at least one user.

A fifth aspect of this disclosure relates generally to a method for increasing vocabulary comprising the steps of parsing, by a processor, at least one user input into at least one keyword, generating, by a processor, a database of keywords, calculating, by a processor, at least one frequently used keyword of the database of keywords, selecting, by the processor at least one frequently used keyword for further analysis, searching, by a processor, an information repository for an alternative word to the at least one frequently used keyword, compiling, by a processor, the information retrieved during the search of the information repository, and presenting, by the processor, the information to at least one user.

### BRIEF DESCRIPTION OF THE DRAWINGS

Some of the embodiments will be described in detail, with reference to the following figures, wherein like designations denote like members, wherein:

FIG. 1 depicts a block diagram of an embodiment of a computing system;

FIG. 2a depicts a flowchart of an embodiment of a computing system collecting, analyzing and presenting custom content based on information of a user;

FIG. 2b depicts a flowchart of an embodiment of a computing system collecting, analyzing, retrieving and presenting custom content based on user information;

FIG. 3 depicts a diagram of an embodiment of computing system providing customized content based in a user's interaction with said computing system;

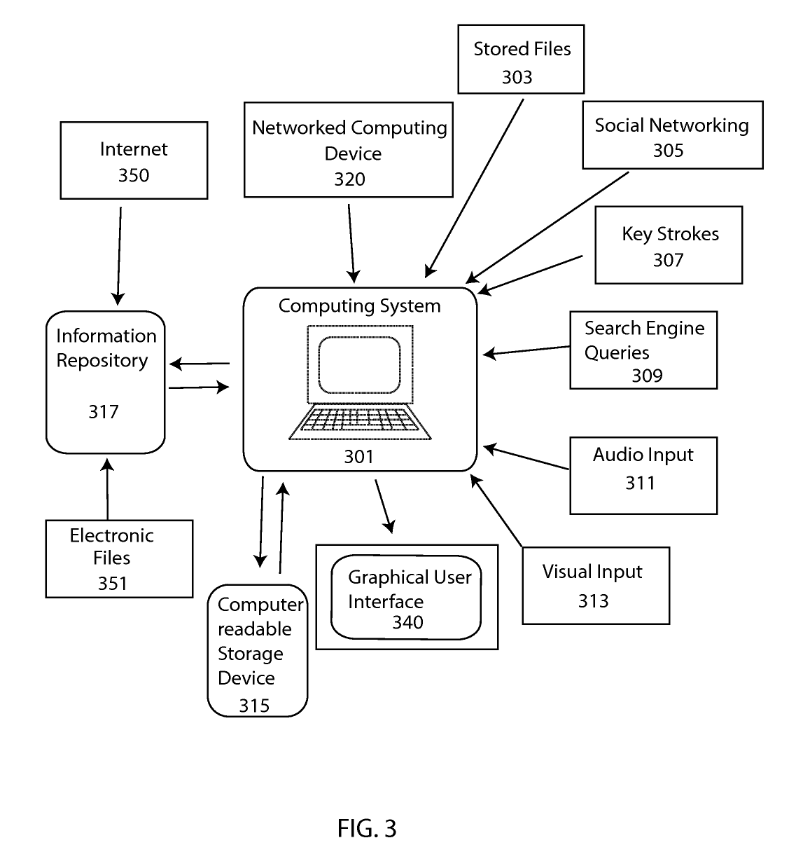

FIG. 4 depicts a flowchart of an embodiment of a computing system categorizing and storing user input in a retrievable format; and

FIG. 5 depicts a flowchart of an embodiment of a method for increasing vocabulary.

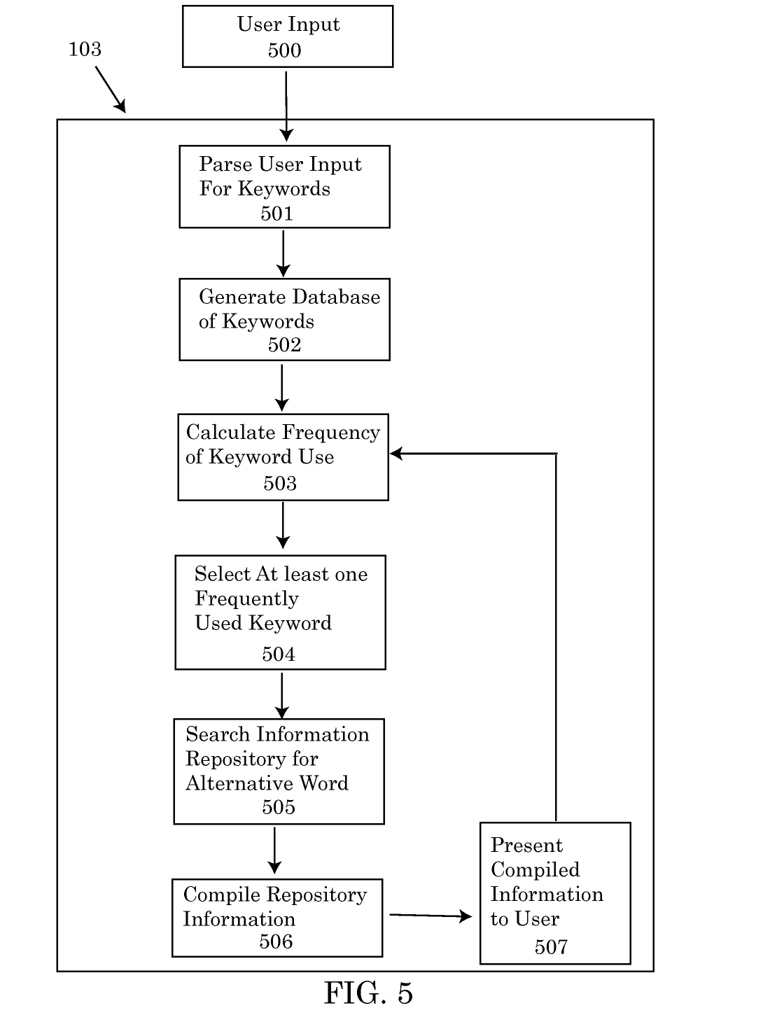

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

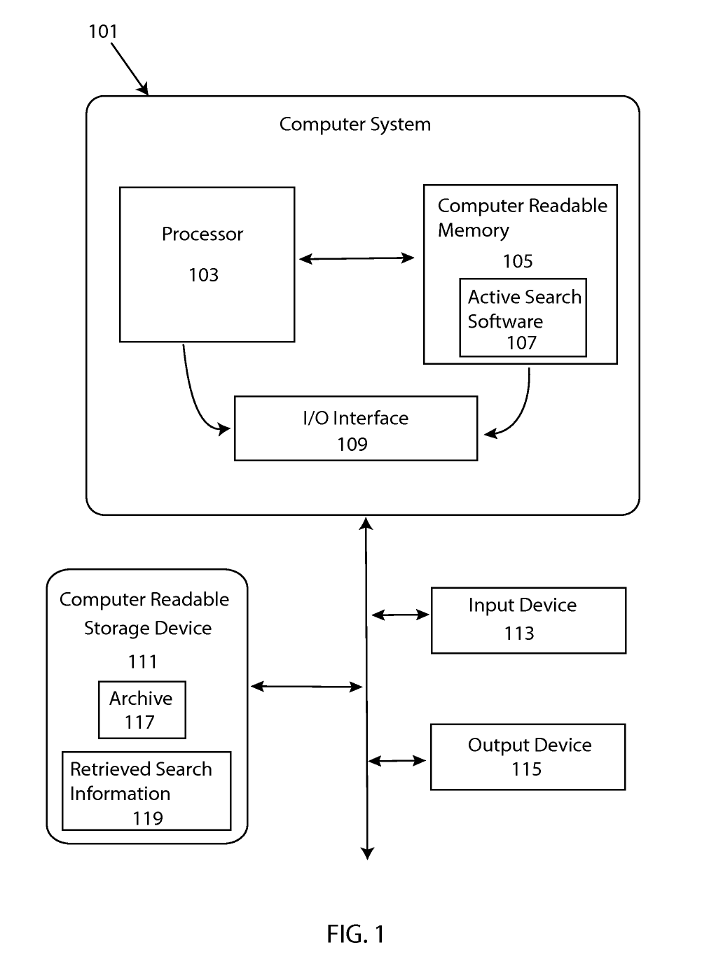

FIG. 1 depicts an embodiment of a computing system 101. A computer system 101 may include any device or apparatus which may contain a processor 103, computer readable memory 105 and an input and output interface 109. Examples of computer systems may include desktop computers, laptops, tablets, chromebooks, smartphones or other mobile phones, televisions, video game consoles, smart appliances, media player devices such as an iPod or iPod-like device and media devices integrated with automobiles.

The processor 103 may be any device or apparatus capable of carrying out the instructions of a computer program. The processor 103 may carry out instructions of the computer program by performing arithmetical, logical, input and output operations of the system. In some embodiments, the processor 103 may be a central processing unit (CPU) while in other embodiments, the process may be a microprocessor. In an alternative embodiment of the computing system, the processor may be a vector processor, while in other embodiments the processor may be a scalar processor. Additional embodiments may also include a cell processor or any other existing processor available. A computing system 101 may not be limited to a single processor 103 or a single processor type, rather a computing system 101 may include multiple processors and multiple processor types within a single system that may be in communication with each other.

The computing system 101 may also include computer readable memory 105. Memory 105 may be a device used to store programs such as sequences of instructions or the memory may store data such as programmed state information. The memory 105 may store programs or data on a temporary or permanent basis. In some embodiments, memory 105 may be primary memory while in alternative embodiments, the memory 105 may be secondary memory. Additional embodiments may contain a combination of both primary and secondary memory.

Embodiments of primary memory may include addressable semi-conductor memory such as flash memory, ROM, PROM, EPROM, EEPROM, RAM, DRAM, SRAM and combinations thereof. Embodiments of a computing system which include secondary memory may include magnetic tape, paper tape, punch cards, magnetic discs, hard disks, and optical storage devices. Furthermore, additional embodiments using a combination of primary and secondary memory may further utilize virtual memory. In an embodiment using virtual memory, a computing system may move the least used pages of primary memory to a secondary storage device. In some embodiments, the secondary storage device may save the pages as swap files or page files. In a system using virtual memory, the swap files or page files may be retrieved by the primary memory as needed.

The computing system 101 may further include an input/output (I/O) interface 109. The I/O interface 109 may act as the communicator between computing device and the world outside of the computing system. Inputs may be generated by users such as human beings or they may be generated by other computing systems. Inputs may be performed by an input device 113 while outputs may be received by an output device 115 from the computing system 101. Embodiments of an input device 113 may include one or more of the following devices: a keyboard, mouse, joystick, control pad, remote, trackball, pointing device, touchscreen, light pen, camera, camcorder, microphones, biometric scanner, retinal scanner, fingerprint scanner or any other device capable of sending signals to a computing system. Output devices 115 may be any which provides a form of communication from the computing system 101 in a human readable form. Embodiments of a computing system 101 which include an output device 115 may include one or more of the following devices: displays, monitors, printers, speakers, headphones, graphical displays, tactile feedback, projector, televisions, plotters, or any other device which communicates the results of data processing by a computing device in a human-readable form.

Embodiments of a computing system may include some form of computer readable storage device 111. A computer readable storage devices 111, may include any form of primary or secondary memory described above, including magnetic tape, paper tape, punch cards, magnetic discs, hard disks, optical storage devices, flash memory, solid state memory such as a solid state drive, ROM, PROM, EPROM, EEPROM, RAM, DRAM.

Embodiments of a processor 103 of a computing system 101 may execute or implement steps according to an active search software 107 loaded in their memory 105. Embodiments of the active search software 107 may be any set of machine readable instructions which may direct the computing system 101 processor 103 to perform one or more specific operations. In alternative embodiments, the active search software 107 may be a source code, binary code or a combination thereof. In some embodiments, the active search software 107 may be in the form of application software. As seen in the exemplary embodiment depicted in FIG. 1, the active search application may be loaded into the computer readable memory 105 of the computing system. In alternative embodiments, the active search software may be embedded software which may reside in the firmware of embedded systems.

Embodiments of the active search software 107 may be programmed to collect information about one or more individuals using the computing system 101 or a computing system that may be networked 320 with computing system 101 while the computing system 101 is active or idle. User information may be collected for each input a user provides to the system 101. Collected user information may assist the computing system by informing the computing system 101 about the user's interests, hobbies, environment, affiliations, home, past, financial status, medical records, age, gender, religious beliefs, employment, friends, family, significant other, and the like. A computing system 101 may use the collection of user information to determine user patterns to make, suggest, and/or present predictions and/or suggestions about future user activity or information consumption. The computing system may be able to aggregate the information received from the user input and the computing system may use this pool of information to research and present content to the user that will suit the user's needs and interests.

In some embodiments, the computing system 101 may continuously scan, collect, obtain, search, process, gather, and analyze information associated with at least one user input twenty four hours per day in order to fully understand the user's habits or desire for new knowledge on various topics. In other embodiments the computing system may only analyze collected user inputs within a predetermined time frame, while in other embodiments, the computing system may only analyze and research user input when the computing system is left idle by the user. Embodiments of the computing system 101 may include various data collection devices that may be in communication with the computing system 101, such as peripheral devices carried by the user that can communication with the computing system 101 over a network. For instance, input can be collected by the computing system 101 directly, or one or more peripheral devices such as a bluetooth headset or networked video camera. Data collection devices that may communicate with the computing system may include any computing device which is capable of being networked such as a smartphone, tablet device, voice recorder, camera, camcorder, digital watch, Google Glass® or Google Glass®-like products which may collect user input and transmit the collected input/data to the computing system 101 for analysis.

The computing system 101 may have unrestricted access to collect as much information about the user as possible. In alternative embodiments, the computing system 101 may be restricted in which information may be collected. For example, the active search software 107 may be programmed to exclude certain user inputs or the computing system may be instructed to exclude input related to certain keywords. In yet another alternative embodiment, a user may manually select the information being collected by the computing system. Embodiments of the computing system 101 may collect information about multiple users, such as in a workplace environment.

User input may take any form that may be understood by the computing system 101. For example, in some embodiments, the computing system may scan, collect and/or save information from files saved locally on the computing system 101. For example, stored files 303 including text based documents, cookies, website metadata and emails may be used to collect information from the user. In an alternative embodiment, websites visited by the user may reviewed by the computing system. In addition to the actual website being reviewed, the computing system may also review activity conducted on interactive websites such as social networking sites 305, search engines 309 and forums. Some interactive websites even allow comments to be entered by users, these comment sections may be scanned and analyzed by the computing system. In alternative embodiments the computing system 101 may review and keep logs of user key strokes 307. In yet another embodiment, a computing system 101 may keep track of search terms entered into a search engine 309 and the subsequent webpages accessed in order to assess and categorize which information may be most important to the user.

In yet other embodiments, user input may additionally include audio input 311. Audio input may be received and potentially recorded by the computing system via a microphone, digital sound recorder or any other method capable of recording sounds—digital, analog or acoustic. Audio input 311, which the computing system may analyze for user information, may be any auditory sounds which the computing system's 101 input device 113 may receive and record. For example, in one embodiment, the computing system 101 may record audible speech by the user, either through one or more microphones in direct or wireless communication with the computing system 101, including microphones of a peripheral device. In an exemplary embodiment, the computing system 101 may suggest new words to improve a vocabulary of the user. In other embodiments, the computing system may record sounds from nearby media devices such as a television broadcast, a movie being played or music. The computing system 101 may identify the source of the sound and incorporate it into its analysis of customized content for the user. In another embodiment, the computing system 101 may record background noise of the environment. For example, the computing system may identify noises made by pets, children, household devices and equipment, vehicles, coworkers, guests, customers, teachers, students, home appliances, and the like.

In some embodiments, the computing system 101 may be capable of detecting the voice signature of the user. By determining the user's voice signature or differentiating multiple user voices, the computing system 101 may be capable of separately analyzing each user's activities and provide more custom tailored content for that specific user, by forgoing audio attributed to non-users. In some embodiments multiple computing devices may be networked together or share analysis with other networked devices. For example a mobile phone and a desktop computer may communicate user input with each other. The mobile phone may record telephone conversations and mobile network internet viewing information and share it with the desktop computer which may result in unified custom user experience and specific content across the spectrum of the user's devices. In additional embodiments, an environment may be recorded using numerous input devices networked to a computing system which may analyze all of the incoming data. For example a store or business may include multiple cameras or voice recording devices throughout the business. These recording devices may pick up environmental sounds, discussions, body language and other information about visitors to provide feedback to the owner so the owner may adjust and anticipate customer needs.

In an alternative embodiment, user input may take the form of visual input 313. For example an embodiment of a computing system may be equipped with a camera or a video recording device, allowing the computing system to capture and potentially save video files and images. The captured and/or stored video input or images may be analyzed by the computing system 101 for visual clues about the user and their surroundings in order to offer customized content for the user. For example, a computing system 101 may use a video recording device to analyze the user, their clothing and their surrounding environment and in turn the computer may suggest content accessible by the computing system that may compliment the user and their surrounding environments. For example, a user may be drinking a cup of coffee while using the computing system. The computing device may activate the video recording device attached to the computing device to observe the user. The computing system may analyze the user input and recognize that the user enjoys coffee. Subsequently, the computing device may provide the user with suggested local coffee houses, locations to buy the best coffee, mugs, and accessories or even search the web for coupons that may be useful for the user's coffee drinking habit.

In another embodiment, the computing system may incorporate multiple forms of information to make predictions and logical conclusions about the user. For example, the computing device may use visual input from a recording device, GPS and locally stored information on the computing device synergistically. A computing device with the video recording device active may spot the user and using GPS determine that the user is currently at their house. The computing system may cross check this information with the user's stored calendar which states the user should be at an appointment. The computing system may logically conclude that the user has forgotten about the appointment and present custom information alerting the user to the impending appointment.

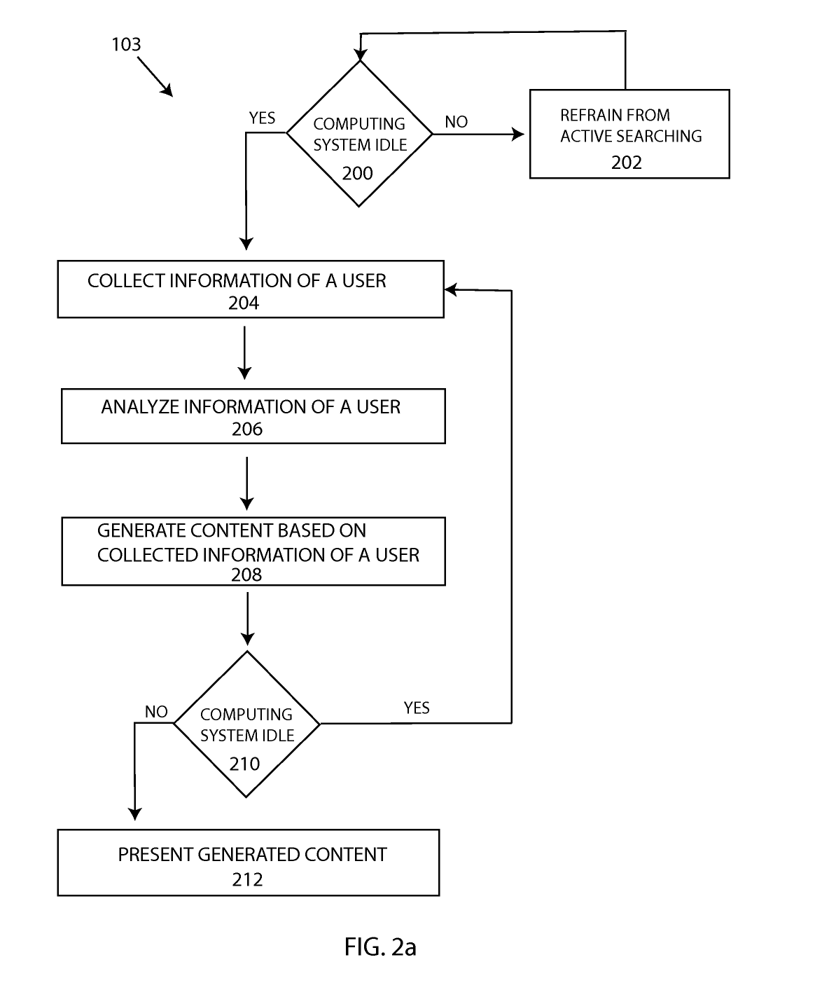

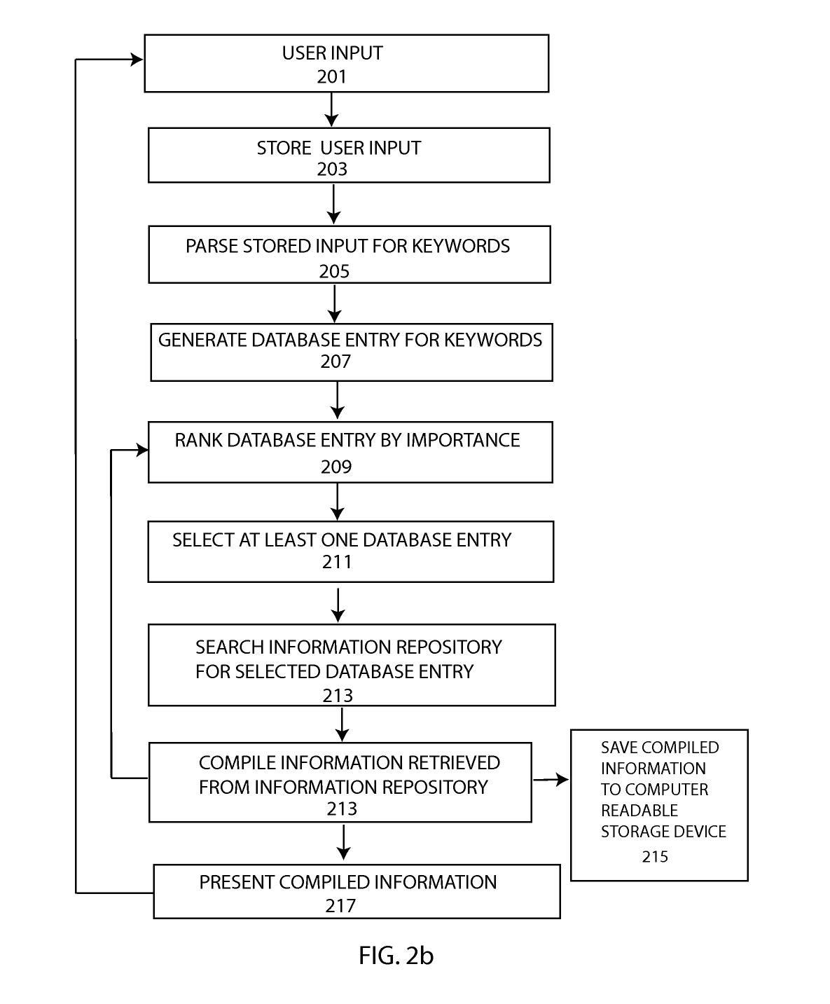

FIG. 2a depicts a method of active searching which may include collecting 204 by a processor of a computing system 101 at least some information about at least one user. This collected information may be obtained by the computing system recalling previous user activity of the user while engaged with the computing system, and observing and listening to the user and the user's surroundings with the computing system 101 or other networked computing devices. In some embodiments, the computing system may conduct the observation and collection user information while the computing system is idle. In other embodiments, the computing system may be actively used by the user. In the embodiment wherein the computing system is actively used, the computing system 101 may be collecting information about the user's activities on the computing system or networked computing device in real time. The processor of the computing system may analyze 206 the information of the user to generate 208 content for the user, wherein the content is in response to the collected information of the user based on the user's input. The processor may then present 212 the content to the user. The action of collecting and the analyzing by the processor of the computing system may be performed when the computing system is either active or idle 200. In an embodiment wherein the collection, analysis and/or generation of user information and content occurs when the computing system 101 is idle, the computing system may continue collecting, analyzing, and generating user information and content until the computing system is no longer idle.

In some embodiments, the user may interrupt the step of collecting 204, analysis 206 and/or the generation of content 208. In some embodiments, the computing system may pause and continue where the computing system left off prior to presenting the content to the user. In other embodiments, the computing system may continue the method until the step of presentation even after the method has been interrupted by no longer being idle.

In an exemplary embodiment, a computing system 101 may include and analyze one or more of the various types of input. Multiple forms of input may increase the total amount of information about the user and allow for the computing system to recognize more complex patterns and scenarios associated with the user and allow the computing system to more effectively tailor content and suggestions specific to the user that are more accurate and more likely to be useful to the user.

FIG. 2b depicts an embodiment of a method for actively searching to generate customized content based on the individual user, with a computing system 101 loaded with the active search software 107 in its memory 105. In one embodiment of this method, the user input 201 may be received by the computing system 101 processor 103. Upon receipt, the user input 201 received by the processor 103 may be stored 203 for further parsing at a later point in time. The user input for example may be archived and stored as database entries 207 created and stored in the computing system deriving from parsed keywords 205. In alternative embodiments, the processor may continue to analyze and parse the user input 201 for keywords, immediately upon receipt of the user input. In an embodiment wherein the processor parses stored user input 203 at a later point in time, the processor may conduct the further examination at a preprogrammed time according to the instructions of the active search software, a time specified by the user or at a point in time wherein the processor 103 has a decreased processing load such as an idle period.

In one embodiment, user input 201 may be archived 117 in the computer readable storage device 111 of the computing system 101. In some embodiments, the user input 201 may be stored or saved directly as raw data. Raw data may be the form which the user input 201 was received by the computing system. For example, the user input 201 may include a website visited by the user as an html file. The processor may store the received html file in the archive 117 as an html file. In another example, the computing system may collect audio input 311 in a specified format such as a .wav or .mp3. The audio may be subsequently stored in the archive in the file format received. In alternative embodiments, the processor may convert or store the user input 201 as a compressed file or in a file format which is decreased in size over the raw data format. The compressed file may be advantageous where there is limited storage space, or there is a massive quantity of received user input 401. In this embodiment, the processor may convert the raw data into a small file which may experience deterioration in the quality of the user input 201 but may still be useable by the computing system for the purpose of cataloging keywords and analysis. For example, instead of storing a website in html format, the website may be stored as a .txt file, or in the case of an audio file, the audio file may have its bit rate down sampled. For example, an audio file may be down sampled from the raw data .mp3 of 360 kbps to 128 kbps.

Archived user input 201 may be stored temporarily, permanently, contingently depending on the embodiment of the computing system. In an embodiment using a temporary archival system, the archived user input 201 may remain stored in the computer readable storage device 111 until the user input 201 is examined and parsed for keywords 205. In an embodiment utilizing a permanent storage method, the computing system may keep the user input 201 stored in the archive 117 until a user deletes the file or formats the computer readable storage device 111. In an embodiment utilizing a contingent system for storing archived 117 user input 201, the user input may remain archived even after the user input has been parsed for keywords until a certain specified event occurs. The specified event may differ in each embodiment. For example, in some embodiments, the computing system may leave the user input archived until storage space in computer readable storage device 111 reaches some minimum threshold. In another embodiment, the user input 201 may remain archived for a set time frame. In yet another alternative, the computing system may delete all parsed user input on a cyclical basis such as once a week, once a month or any scheduled time period. In another embodiment, User input 201 may remain after parsing until the next user input is received. At the point of receipt the oldest user input may be deleted and the newest user input may be archived.

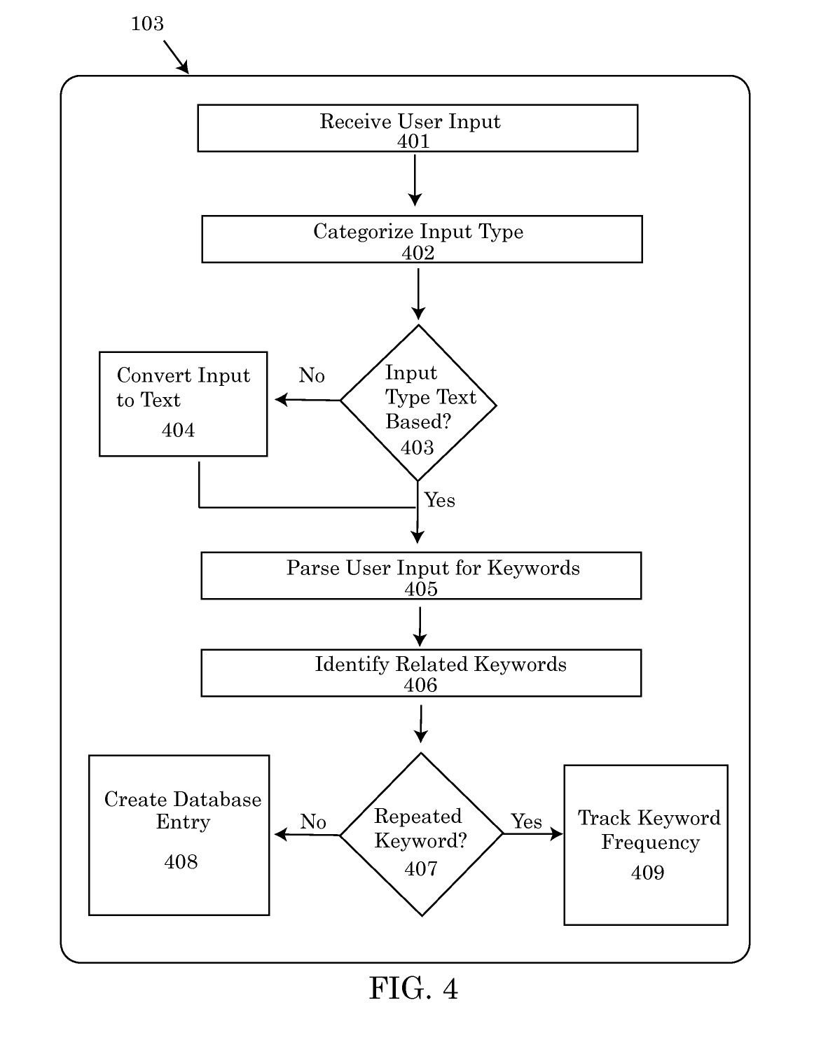

FIG. 4 depicts an embodiment of method for archiving received user input 401. In some embodiments user input may be received for archiving and immediately parsed for key words. In alternative embodiments, user input may be received by the computer readable storage device 315 for archiving to be parsed at a subsequent point in time. In some embodiments, the received user input 401 may be categorized by the type of user input. For instance, the processor may categorize the user input type 402 by file type such as audio, visual, text or combinations thereof. One example of a file type with a combination of visual and text may be a webpage. Webpages often include images, videos and written text, as well as a source code which may be parsed for keywords. Each type of user input may be parsed separately or the entire webpage may be parsed as a whole.

In alternative embodiments, the processor may categorize the input type by input device the user uses. For example, the user input entered by a keyboard may be commonly classified while locally stored documents may be a separate category. In addition, audio and visual information may be two additional categories as well. In yet other alternative embodiments, input may be categorized by the file extension which the received user input may be saved as. For example, the processor may sort JPEG's separately from .Doc files and .mp3's separately from .wav files, as well as .avi video files separately from .mp4 or .wmv video files.

In some embodiments, the step of categorizing input type 402 may assist the processor in determining whether or not the input type is text based 403. For example in an embodiment wherein the input type is categorized by file extension, a processor 103 may be given instructions which may associate each file extension as text based or not. For example, a processor 103 may be instructed by the active search software 107 that file extensions such as .doc, .pdf, .txt, .wpd, .rft are text formatted files while .avi, .mkv, .JPEG, .TIFF, and .BMP are not. In some embodiments, wherein the processor is unable to determine whether a file extension is a text based file or not, the active search software may provide additional instructions to the processor to consult a specific source such as a designated webpage, or server updates may be able to provide the most up to date list of file extensions.

In an alternative embodiment, the processor may receive instructions determining whether a user input is text based, depending on which input device is generating the user input. For example, in one embodiment, the processor 103 may receive programming instructions to classify all keyboard input as text based because the keystrokes may be logged in text files. In other embodiments, user input generated by an audio input such as a microphone, may be classified as not text based because the input is stored in a sound file. Similar to the previous embodiment, the processor may also be instructed that input received by the computing system which originates from a visual recording device is not text based, but rather a video file.

If an embodiment of the computing system receives a text based user input, such as a series of keystrokes, website addresses, search engine queries, emails, text messaging, social media posts or a locally stored text file, the processor may parse the language of the file for keywords. The generation of keywords may provide the computing system with terms or phrases associated with a user. These terms or phrases may be further researched by the computing system to create customized content and provide suggestions to the user. For example, if the user leaves a message to a friend that he is planning on taking a vacation to a beach, the processor 103 may recognize “planning,” “vacation,” and “beach” as keywords. Upon researching these keywords alone, or in conjunction with other known keywords associated with the user, the computing system may be able to suggest a beach vacation destination based on the known user interests, budget information, GPS location and previously enjoyed vacation destinations. In addition, the computing system may also suggest other content such as travel websites, planning applications, local travel agents, airfare prices, rental cars, hotels, beach accessories, surfing lessons, boat rentals or other items associated with planning such an endeavor.

The computing system may integrate previously archived keywords to make suggestions. Using the vacation example above, if the computing system has previously logged keywords regarding children or parenting, the computing system may suggest to the user a more family oriented vacation destination, a rental car that is a sedan or van rather than a coupe and a hotel room which will accommodate the entire family. The computing system may further incorporate additional keywords. For example, the computing system may have logged previous keywords associated with pets. The computing system may bridge this previous knowledge regarding pets with the message about planning a vacation. As a result, the computing system may refine the customized content presented to include pet friendly destinations, pet watching services, a local kennel, or contact information for friends and family who have been asked to look after the user's animals in the past.

In some embodiments the user input received by the computing system may not be text based 403. In this embodiment, the processor may first convert the non-text based files into a readable text format. The conversion step 404 may differ depending on the type of file being converted to text. In an embodiment receiving an audio file containing speech, environmental sounds such as music, movies, television broadcasts, animal noises or the sound of anything else that can be captured in an audio file, the processor may decode the audio file and convert it to a textual transcript. For example, the processor may render audible speech into words, creating a written transcript of a conversation.

In an alternative embodiment, the non-text based user input might not be converted to text first, instead the information presented in the non-text input may be analyzed in the stored format and keywords may be generated based on the analysis. In some embodiments the computing system may be capable of sound or image recognition. For example, the processor may recognize a sound that appears to be music, a movie, television broadcast or other media. Subsequently, the computing system may be capable of searching a database of musical compositions, movies, television broadcasts or other media and ascertain the origins of the audio recorded, and create keywords associated with the audio file.

In another embodiment, the processor may compare the sounds recorded in an audio file with a known database of sounds in order to create a custom list of keywords associated to that audio file. For example, the audio file may contain a distinctive noise such as a dog barking. The processor may include as keywords, among other things, words associated with pets, or may specifically create a keyword relating to the specific type of animal. In another example, the processor may recognize the sound of children laughing, subsequently, keywords associated with children will be identified. In alternative embodiments, the processor may make assumptions about the input received. For example, the presence of children may suggest that the user is a parent, further customizing the content to include parenting related content or family friendly content associated with other keywords derived from user input.

Additional embodiment of a computing system with active search software may be capable of generating keywords based on user input is a video file or image files by using image recognition or computer vision. The processor may compare the images that make up the video or the still image to a database of images, in search of a match. The processor may formulate keywords based on the visual data of the video file. For example, when a processor is scanning an image for matches in a database of images, it may notice particular clothing, brands or styles worn by the user. The processor may also scan and compare the user's environment against the database of images. For example, upon scanning the environment in the video file, the processor may identify matches for items seen in the surrounding environment such as paintings, pictures, media content such as books, movies, music and videogames, toys, guns, sporting equipment, cookware, electronics or any other item that may be visible in a video file. Upon identifying one or more items from the video file, the processor may create keywords associated with the items and themes based on those identified in the video file. In some embodiments, the processor 103 may also be able to identify locations or landmarks which may be observable in the video file.

In another embodiment, the input received may be images retrieved using content-based image retrieval (CBIR). In other embodiments, the input received may be semantic retrieval. For example the computer may recognize commands such as “find pictures of New Orleans.” Other semantic retrieval input may be directed to colors, textures or shapes. For example, a user may supply a command to retrieve information about navy blue wool suits or objects which can be molded into the shape of flowers.

In some embodiments, the user providing the user input may be able to tag items with keywords manually. For example, a webpage or files may be tagged with meta data describing the content received by the computing system. Other files may have customize meta tags such as uploaded music files which may be tagged with an id3 tag which may include the genre of music, the artist, song title, album title or other similar artists. A processor 103 may recognize tagged user input and automatically generate keywords to archive.

In some of the embodiments, the processor may add or identify related keywords 406 to the list of keywords parsed from the received user input 401. The processor 103 may further evaluate the list of keywords associated with the user input and generate keywords that may be similar in scope, categorically related or synonyms to the identified keyword. The step of identifying related keywords may bolster the amount of overall content that may be researched by the computing system and ultimately presented to the user.

In some embodiments of the computing system 101, the processor may create a searchable and recallable list of organized keywords 408. The organized lists of keywords may be the foundation for archiving database entries which describe the user's input. Database entries may be created for each keyword derived from user input. In alternative embodiments, each database entry may include a cluster of one or more related keywords. The processor may further categorize or combine the entries in any assortment or pattern to facilitate for faster recall. The database entries may each be categorized by multiple categories, in some embodiments of categorization, some keywords may overlap categories. There is an unlimited number category fields for which the data may be categorized.

A computing system utilizing a method of active searching may also seek to limit or track repeated keywords 409. In some embodiments, a database entry of a keyword may only occur one time, so that identical or significantly similar keywords do not contain multiple entries. For example, a repeated pattern of key strokes forming a word constantly may not have numerous entries. Instead, the keyword deriving from the pattern of keystrokes may be determined to be important by the processor 103. In other embodiments, a processor 103 may track the number of times a keyword has been parsed from user input 409. The computing system may correlate the frequency which a keyword is generated to the relative importance the keyword may have to a user.

Keywords repeated more often may be analyzed more often or may be incorporated, in at least some manner, into the custom content delivered to the user. Keywords that are categorized more broadly may have impacts on other keywords being analyzed. For example keywords associated with a lifestyle or genre may exhibit influence on the types of content displayed to the user when a more specific and narrow keyword is derived from user input. For example, the concept of parenting or being a parent which may be archived in the database may affect suggestions for content when the computing system searches analyze keywords about movies. Another example may include archived categories of genres of movies a user may like or dislike. If the user input received discusses wanting to see a new movie, a computing system may tailor the results to genres which are known to be liked and avoid those genres which are known to be disliked.

Keywords that are parsed from user input may be ranked by importance 209. The importance ranking algorithm may aid the computing system in determining which keywords may be researched first for the user. As described above, one factor that may be taken into account when ranking the importance of a keyword may be frequency with which the keyword is generated. Other factors that may be considered when ranking keyword importance may include how recently the keyword was logged into the database, frequency used during a measurable time frame, keywords trending toward a specific topic, and user indicated importance. In addition, keywords may be considered more or less important based on relationships and contextual information received along with the input. For example, the computing system listening to audio of the user, may recognize urgency or other sound cues in the user's voice which may alert the computing system that keywords parsed from the audio may be more important and therefore may be ranked higher. In another example, the received user input may be a conversation between the user and another individual, wherein the text suggests that the surrounding keywords are important or urgent such as “I really need to study for the upcoming biology exam.” In response to this, the computing system may identify biology notes stored on the computing system and research helpful information for studying purposes. In another example, keywords derived from conversations between the user and his significant other or the user's boss may be ranked higher than other user input or derived keywords.

In some embodiments, the computing system may recognize key phrases in written text or in speech that may be given a more urgent significance when determining whether or not a keyword or series of keywords are important. For example, the computing system may be provided with instructions assigning immediate importance to user input that includes phrases such as “I wonder . . . ”, “I need . . . ”, “how should I . . . ” and “do you think I should . . . .”

Embodiments of a computing system actively searching may be able to recognize the user's voice and appearance. The computing system may also be capable of recognizing and labeling relationships between the user and other individuals scanned or analyzed by the computing system. For example, the computing system may be capable of identifying the user's family, significant other, friends, co-workers and boss. In some embodiments, the computing system may rank input from non-user's as highly important. For example, audio being parsed for keywords wherein the speaker is identified as a significant other or the user's boss may be ranked higher in importance than a conversation between the user and friends.

In the exemplary embodiment, the processor 103 may conduct a search of an information repository 211 for the keywords in the database. The computing system may select a keyword 209 to perform a more thorough analysis and to retrieve custom content specifically relating to the generated keyword. In one embodiment, a keyword may be selected for further analysis based on its rank of importance 209 determined by the computing system. In other embodiments, a user may specifically request more information about a specific keyword, database entry, concept or general topic.

The step of searching 211 may be conducted by the processor; keyword by keyword. In other embodiments more than one keyword may researched by the processor simultaneously. In an alternative embodiment, the keyword searching may be conducted by category, while in other embodiments; the keywords which are related in scope may be searched consecutively. The number of keywords searched at a given time may be limited by computing resources available. For example, an idle processor that is not being utilized by a user may research more keywords relating to the received user input than if the processor is simultaneously being utilized by the user for at least one separate function. The number of database entries being researched may also be limited by the hardware or processing power of the computing system. A computing system which is more powerful or more modern may be more capable of searching more entries at one time and at a faster pace than a much less powerful computing system. In an alternative embodiment, a computing system may be powerful enough to search every un-researched database entry at the same time, while embodiments featuring a less powerful computing system may only be capable of researching a few entries at a time or even a single entry at a time.

A processor may consult an information repository 317 when researching database entries. The information repository may be a compilation of all information available to the computing system. The information repository may include any information accessible by the processor 103 and the computing system, including but not limited to locally stored or networked files 351, the internet 350, web pages, encyclopedias, dictionaries, networked computing devices, emails, newsfeeds, user profiles generated by other users of the computing system, stored contacts, calendar information, databases, and any other information accessible by the computing system. The computing system may consult one or more types of references when consulting the information repository to research keywords. In some embodiments, the user may be able to provide guidance to the computing system's searching function. For instances, the user may recommend sources that the user prefers to have customized content derived from.

Information retrieved from the information repository may be saved or archived in a manner similar to received user input. In some embodiments, information saved and retrieved may be associated or connected with the database entry which may include one or more keywords. Compiled information retrieved 213 and saved 215 from the information repository may be stored locally or in web based cloud storage. The files may be recalled when needed to present to the user. Retrieved information may be bundled with other information similar in scope or the retrieved information may be saved as a single file. The processor may also bundle retrieved information based on the date all the information was retrieved. The processor may compile the retrieved information into any format that may be readable by a human or any format appropriate for presentation to the user. In some embodiments, retrieved information may be saved in a raw and uncompressed format. In an alternative embodiment, the processor may compress and save files to a format smaller in size than the raw data retrieved from the information repository.

The computing system 101 engaging in an active search may present 217 the compiled retrieved information to the user in a human readable form. In some embodiments, the retrieved information may be presented to the user in the format the information is found in. For example, a computing system may receive user input which may be parsed for keywords relating to space travel and exploration. In response, the computing system may provide encyclopedia entries and websites associated with space exploration to the user. In alternative embodiments, the retrieved information may form the basis for the customized content viewed by the user. Using the space exploration example above, instead of the computing system bringing webpages or encyclopedic entries themselves to the user's attention, the active search software may present the user with a prompt suggesting the user check out the following links and within each link may be the websites or encyclopedic entries among other destinations.

The presentation of the retrieved information may vary from embodiment to embodiment. In some embodiments, the retrieved information may be presented to the user using an output device such as a monitor or printer. In an alternative embodiment, the active search software may create a pop-up window so upon return to the computing device, the user may immediately notice the computing system's findings. In other alternative embodiments, the computing system may notify or present information to the user via a graphical user interface 340 such as by using an icon informing the user that custom information is available. In additional embodiments, the computing system may deliver the information to other networked devices, email the user, send a text based message to the user's mobile device or contact the user through any other method a computing system may be capable of using to present the information retrieved.

An alternative embodiment of the active searching method described above may be used to increase the vocabulary of a user. Similar to previous embodiments described above, processor may save and catalogue user input 500 by parsing user input into keywords 501 then the computing system may generate a database of keywords 502 by archiving the keywords as entries in a database. For example, in one embodiment, the user input may be converted into text and parsed for keywords. In an alternative embodiment, the processor may focus on the speech, written language and vocabulary of the user and parse the speech, written language and vocabulary for keywords. The computing system may review the keywords and calculate the frequency 503 that a keyword is generated and entered into the database. Based on the frequency 503 of a keyword being used, the computing system may search the information repository for alternative words and synonyms the user may use instead of the frequently used keyword. The computing may compile the information retrieved from the information repository 506 and present the compiled information to a user 507. In one embodiment, the computing system may present the user with a prompt or notification the next time the frequent keyword is used. For example, if the user is writing an email or a text message, the computing system may underline the word a specific color, while in other embodiments, the computing system may include a dropdown menu or other interface feature for the user to select a desired synonym. In other embodiments, the computing system may alert the user to the overuse of the word and supply a list of suggested alternatives. In yet another alternative embodiment, the computing system may automatically replace the frequently used keyword with a less frequently used alternative.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A method comprising:
collecting, by a processor of a computing system, information of a user;
analyzing, by the processor of the computing system, the information of the user to generate content based on the collected information of the user; and
presenting, by the processor of the computer system, the content when the computing system is not idle.

2. The method of claim 1 wherein the information of a user is at least one of visual input, audio input, key strokes, website history, stored files, search engine queries, networked computing device activity and social networking activity.

3. The method of claim 1 wherein information of the user includes information of a surrounding environment.

4. A computer system for actively searching and improving information available to a user comprising:
a processor;
a computer-readable memory;
a computer-readable storage device;
first program instructions for storing user input;
second program instruction for parsing user input into at least one keyword;
third program instructions for generating a database including the at least one keyword;
fourth program instructions for selecting a database entry from the database;
fifth program instructions for searching an information repository for information related to the data entry from the database; and
sixth program instructions for displaying information retrieved relating to the search of the information repository;
wherein the first program instructions, the second program instructions, the third program instructions, the fourth program instructions, the fifth program instructions and the sixth program instructions are stored on the computer-readable storage device for execution by the processor via the computer-readable memory.

5. The computer system of claim 4, wherein the user input is selected from the group consisting of text files, keystrokes, locally saved files, search queries, audio recordings, video recordings and combinations thereof.

6. The computer system of claim 4, wherein the information repository is comprised of the internet.

7. A method for actively searching comprising the steps of:
receiving, by a processor, input from a user;
parsing, by the processor, the input into at least one keyword;
generating, by the processor, a database entry including the at least one keyword;
selecting, by the processor, at least one database entry;
searching, by the processor, a information repository for information relating to the at least one database entry;
compiling, by the processor, the information relating to the at least one database entry; and
presenting, by the processor, the information to at least one user.

8. The method of claim 7, wherein the input is selected from a group consisting of a webpage, search engine query, audio file, video file, image file, text file, keystroke and combinations thereof.

9. The method of claim 7, wherein the information repository includes at least one electronically formatted file.

10. The method of claim 7, wherein the information repository is the internet.

11. The method of claim 7, further comprising an additional step of repeating, by the processor the previous steps indefinitely until at least one of the following occurs: every database entry has been actively searched and a user directs the active searching to cease.

12. The method of claim 7, further comprising an additional step of storing, by the processor, the information relating to the at least one database entry.

13. The method of claim 12, wherein the step of storing includes saving the information, by a processor, to a hard disk drive.

14. The method of claim 7, wherein the step of presenting, by the processor, the information to at least one user further includes displaying, by the processor, the information on a graphical user interface.

15. A computer program product for actively searching and improving information available to a user comprising:
a computer-readable storage device;
first program instructions for generating a database of user input;
second program instructions for converting the user input into a database entry of at least one keyword;
third program instructions for selecting at least one database entry for further analysis;
fourth program instructions for searching a information repository for information relating to the at least one database entry;
fifth program instructions for compiling information related to the at least one database entry; and
sixth program instructions for presenting the compiled information to at least one user.

16. The computer program of claim 15, wherein user input includes at least one of a creation of documents, keystrokes, search queries, audio recording and visual recording.

17. The computer program of claim 15, wherein the step of selecting at least one database entry for further analysis depends on criteria selected from a group consisting of a repeated pattern of keystrokes, performing a search query, triggering a pre-programmed key phrase and combinations thereof.

18. The computer program of claim 15 wherein the information repository includes a document recognizable in electronic format.

19. The computer program of claim 15 wherein the information repository is the internet.

20. The computer program of claim 15 further comprising a seventh instruction for storing the information relating to the at least one database entry.

21. The computer program of claim 20 wherein the seventh instruction for storing information saves the information onto a hard disk drive.

22. The computer program of claim 15 wherein presenting information includes displaying information on a graphical user interface.

23. A method for increasing vocabulary comprising the steps of:
parsing, by a processor, at least one user input into at least one keyword;
generating, by a processor, a database of keywords;
calculating, by a processor, at least one frequently used keyword of the database of keywords;
selecting, by the processor at least one frequently used keyword for further analysis;
searching, by a processor, an information repository for an alternative word to the at least one frequently used keyword;
compiling, by a processor, the information retrieved during the search of the information repository; and
presenting, by the processor, the information to at least one user.

24. The method of claim 23 wherein the alternative word is a synonym of the at least one frequently used word.
